(19) United States
(12) Patent Application Publication
(10) Pub. No.: US 2025/0340061 A1
(43) Pub. Date: Nov. 6, 2025

(54) INK REPLENISHING CONTAINER, METHOD FOR MANUFACTURING INK REPLENISHING CONTAINER, AND METHOD FOR REMANUFACTURING INK REPLENISHING CONTAINER

(71) Applicant: CANON KABUSHIKI KAISHA, Tokyo (JP)

(72) Inventor: TAKURO INABA, Kanagawa (JP)

(21) Appl. No.: 19/193,690

(22) Filed: Apr. 29, 2025

(30) Foreign Application Priority Data
May 1, 2024 (JP) 2024-074435

(51) Int. Cl. B41J 2/175

(52) U.S. Cl. CPC B41J 2/17513; B41J 2/17509; B41J 2/17553; B41J 2/17559; B41J 2002/17516

(57) ABSTRACT

An ink storage member having an opening, a container body that can store the ink storage member, and a cap that can be attached to and detached from the container body and can seal the opening of the ink storage member stored in the container body, in which a recessed portion which is recessed toward an inner side of the ink storage member from an outer peripheral surface is provided in a closest region which is closest to at least an inner peripheral surface of the container body in an outer peripheral surface of the ink storage member, and the recessed portion does not come into contact with the inner peripheral surface of the container body. This may facilitate reuse of the container body, and thus the technologies described in this specification have the potential to contribute to the achievement of a sustainable society, such as a decarbonized society/circular society.

### BACKGROUND OF THE INVENTION

### Field of the Invention

The present invention relates to an ink replenishing container, a method for manufacturing an ink replenishing container, and a method for remanufacturing an ink replenishing container.

### Description of the Related Art

In an inkjet printer that performs recording on a recording medium such as paper by discharging ink from a head that discharges ink onto the recording medium, there is an inkjet printer that can replenish ink from an ink replenishing container to an ink tank of an apparatus main body. In recent years, in order to realize a sustainable society such as a decarbonization society/circulation-type society, there is a demand for a technique for realizing reuse of used products and parts thereof repeatedly, recycling of effectively using wastes and the like as raw materials and energy sources, and reduction of reducing the amount of wastes. For example, Japanese Patent Application Laid-open No. 2022-14549 discloses a technique for reducing the volume of members to be discarded by easily reusing a part of a used ink replenishing container. In the ink replenishing container of Japanese Patent Application Laid-open No. 2022-14549, a film adheres to an inner surface of a container body, and ink is stored in an ink bag made of the film. After the ink in the ink replenishing container is used up, air is blown between the inner surface of the container body and the film to peel off the film from the inner surface of the container body, and the film is removed from the container body. A new film adheres to the inner surface of the used container body from which the used film has been removed, an ink bag is formed, and the new ink bag is filled with ink. Thus, the container body in the used ink replenishing container is reused.

### SUMMARY OF THE INVENTION

In the ink replenishing container of Japanese Patent Application Laid-open No. 2022-14549, the film forming the ink bag adheres almost entirely to the inner surface of the container body, and a large force is required to peel the film from the inner surface of the container body. In addition, there is a possibility that a part of the film is not peeled off and remains on the inner surface of the container body.

An object of the present invention is to provide the ink replenishing container in which the container body can be reused by removing the ink bag accommodated in the container body from the container body so as to facilitate the peeling of the ink bag from the container body and the reuse of the ink replenishing container.

An ink replenishing container for replenishing ink to a recording apparatus that performs recording by discharging ink of the present invention onto a recording medium includes the following configuration.
a bag-shaped ink storage member capable of storing ink, the ink storage member having an opening capable of spouting ink to be stored;
a container body capable of storing the ink storage member; and
a cap attachable to and detachable from the container body, the cap being capable of sealing the opening of the ink storage member stored in the container body,
wherein a recessed portion that is recessed toward an inside of the ink storage member from an outer peripheral surface is provided in a region closest to at least an inner peripheral surface of the container body in the outer peripheral surface of the ink storage member, and
wherein the recessed portion does not come into contact with the inner peripheral surface of the container body.

According to the present invention, in the ink replenishing container in which the container body can be reused by removing the ink bag accommodated in the container body from the container body, the ink bag can be facilitated to be peeled from the container body and the ink replenishing container can be easily reused.

Further features of the present invention will become apparent from the following description of exemplary embodiments with reference to the attached drawings.

### BRIEF DESCRIPTION OF THE DRAWINGS

FIG. 1 is a perspective view illustrating an external appearance of an inkjet printer;

FIG. 2 is a diagram illustrating a state in which ink is replenished to the inkjet printer by an ink replenishing container;

FIG. 3 is a perspective view illustrating the inside of the inkjet printer;

FIG. 4 is a diagram illustrating an external appearance of the ink replenishing container;

FIG. 5 is a cross-sectional view illustrating a schematic configuration of the ink replenishing container;

FIGS. 6A to 6D are diagrams illustrating a method for manufacturing an ink bag;

FIG. 7 is a diagram illustrating a state of peeling of the ink bag;

FIG. 8 is a cross-sectional view illustrating the ink bag taken out from the container body and the container body;

FIG. 9 is a diagram illustrating a state in which a new ink bag is attached;

FIG. 10 is a top view illustrating a state in which the cap of the ink replenishing container of a second embodiment is removed; and

FIGS. 11A and 11B are diagrams illustrating a method for manufacturing an ink bag of the second embodiment.

### DESCRIPTION OF THE EMBODIMENTS

An embodiment of an ink replenishing container according to the present invention will be described. However, the components described in the embodiments are merely examples, and are not intended to limit the scope of the present invention. In the present specification, the “ink” is used as a general term for liquids such as recording liquids.

### First Embodiment

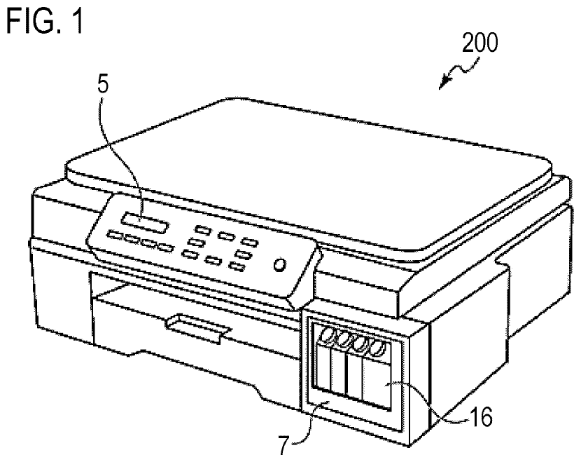

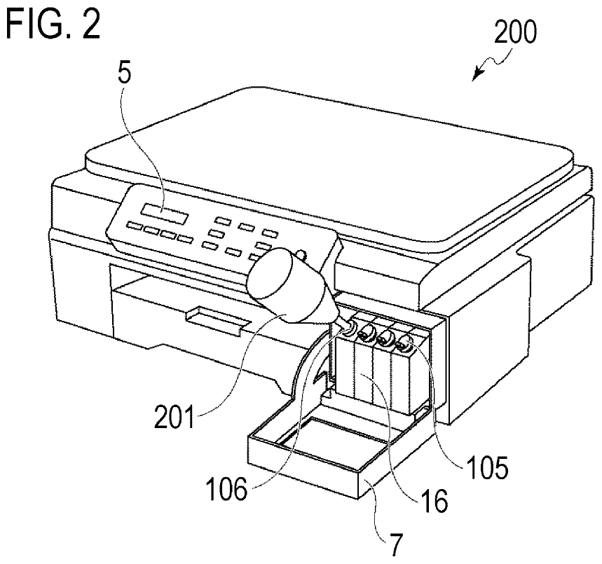

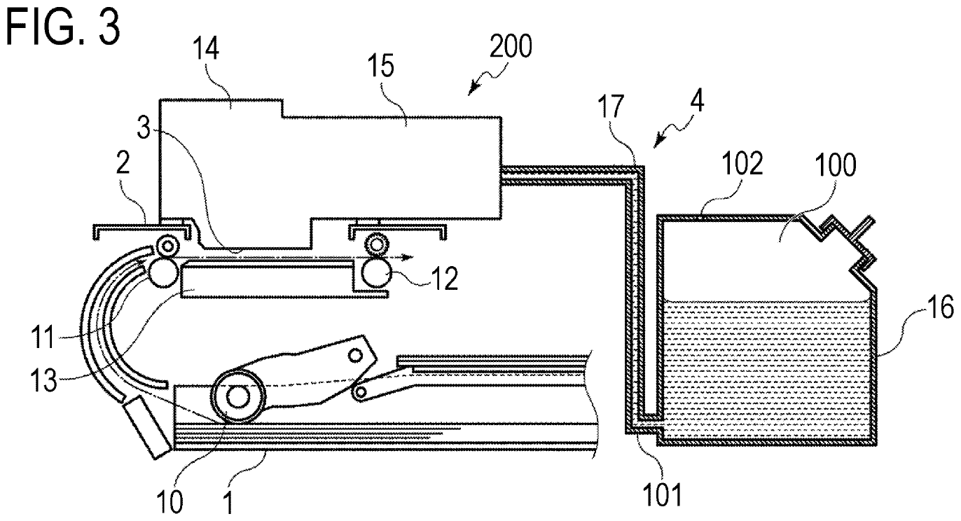

Hereinafter, a first embodiment of the present invention will be described with reference to the drawings. FIG. 1 is a perspective view illustrating an inkjet printer 200 of the first embodiment. FIG. 2 is a diagram illustrating a state in which ink is replenished to the inkjet printer by the ink replenishing container. FIG. 3 is a perspective view illustrating the inside of the inkjet printer. The inkjet printer 200 of the first embodiment is a recording apparatus that discharges liquid ink from a liquid discharging head (hereinafter, referred to as a head) to a recording medium to record an image on the recording medium, and is an example of a liquid discharging apparatus that discharges liquid. In the first embodiment, an inkjet printer will be described as an example, but the liquid discharging apparatus according to the present invention is not limited to the inkjet printer as long as the liquid discharging apparatus has a configuration capable of replenishing liquid from a replenishing container to a tank of an apparatus main body.

The inkjet printer 200 includes a feeding portion 1, a conveying portion 2, a discharging portion 3, a supplying portion 4, and a display portion 5. The feeding portion 1 separates recording media one by one from a bundle of recording media using a feeding roller 10 and supplies the recording medium to the conveying portion 2. The conveying portion 2 is provided on the downstream side in the conveyance direction of the feeding portion 1, and includes a platen 13 that holds a recording medium between a conveyance roller 11 and a sheet ejection roller 12. The conveying portion 2 conveys the recording medium fed from the feeding roller 10 using the conveyance roller 11, the sheet ejection roller 12, and the like.

The discharging portion 3 discharges ink onto a recording medium by a head 15 mounted on a carriage 14. The recording medium conveyed by the conveying portion 2 is supported by the platen 13 from vertically below. Then, the ink is discharged from the head 15 positioned vertically above to form an image based on the image information. An ink tank 16 is a liquid storage container capable of storing ink in the container, and the supplying portion 4 is configured to be able to supply ink from a storage chamber 100 (storage chamber) of the ink tank 16 to the head 15 via a flow path 101 and a flexible supply tube 17. The inkjet printer 200 of the first embodiment performs recording using inks of a plurality of colors of black, magenta, cyan, and yellow. Four supply tubes 17 through which the ink of each color flows extend from the ink tank 16, and are connected to the head 15 in a bundled state.

When the ink supplied to the head 15 is discharged from the discharge port of the head 15, the same amount of ink as the discharged amount is supplied to the head 15 from the ink tank 16. Then, the same amount of air as the ink supplied to the head 15 flows into the ink tank 16 from an atmosphere communication port 102 provided vertically above the ink tank 16. The display portion 5 is used to notify the user of the state of the apparatus in operation, or is used for display when the user selects an operation.

FIG. 2 is a perspective view illustrating a state in which ink is replenished (supplemented) from an ink replenishing container 201 to the ink tank 16 of the inkjet printer 200. To replenish the ink, a cover 7 is opened, and the ink is injected from the ink replenishing container 201 into the storage chamber 100 through an injection port 106 of the ink tank 16. A plug member 105 is a cap attachable to and detachable from the injection port 106, and after the plug member 105 is detached from the injection port 106, ink can be replenished in the ink replenishing container 201. Note that the ink tank 16 is not limited to the configuration incorporated in the apparatus main body of the inkjet printer 200 as in the first embodiment. The ink only needs to be supplied from the ink tank 16 to the head 15. For example, the ink tank 16 may be provided outside the apparatus main body of the inkjet printer 200.

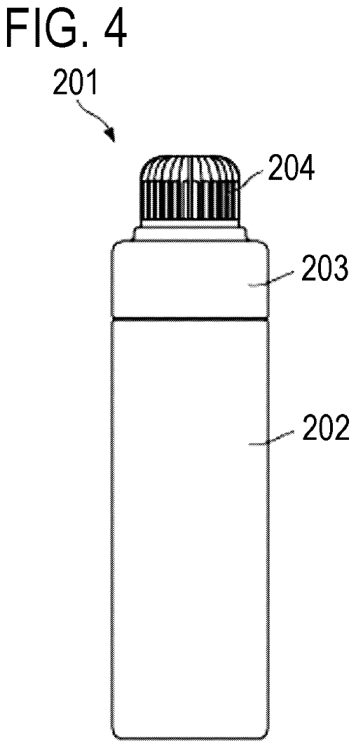

FIG. 4 is a front view of the ink replenishing container 201 in a front-facing state. The front-facing state is a state in which the bottom portion of the ink replenishing container 201 is placed on a horizontal plane. The ink replenishing container 201 includes a container body 202 that stores ink, a spout portion 203 connected to the container body 202, and a cap 204 attached to the spout portion 203, and has a bottle shape as a whole.

The container body 202 has a bottomed cylindrical shape, and an extending direction of the cylindrical shape is an axial direction of the container body 202 and an axial direction of the ink replenishing container 201. A direction perpendicular to the axial direction is defined as a radial direction. The axial direction is parallel to the vertical direction in the front-facing state. The shape of the bottom portion may be circular, rectangular, polygonal, or the like, and is not particularly limited. Ink is stored in the container body 202.

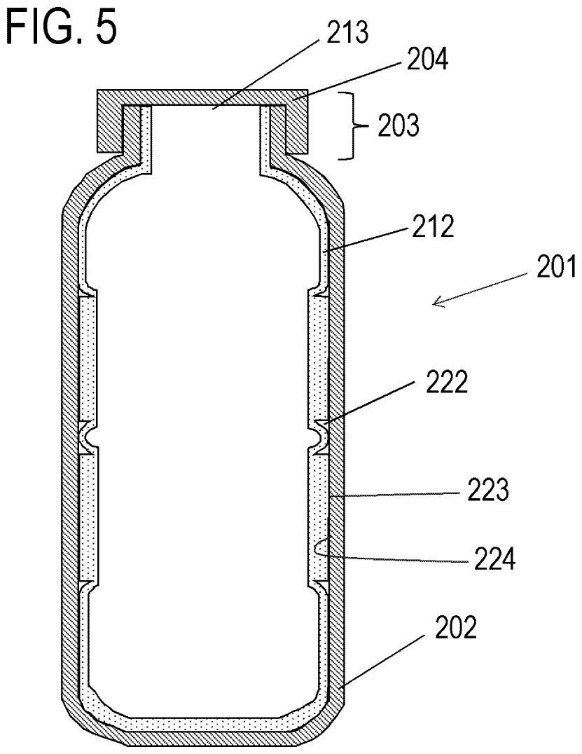

The spout portion 203 is provided on the side opposite to the bottom portion of the container body 202. The spout portion 203 has an opening 213 (see FIG. 5) which is an opening serving as an outlet for spouting (pouring out) the ink contained in the container body 202. The ink in the container body 202 can be spouted from the spout port of the spout portion 203. The cap 204 is attachable to and detachable from the spout portion 203, and the spout port is sealed in a state where the cap 204 is attached to the spout portion 203 to shield the inside of the container body 202 from the outside air. The spout port is opened in a state where the cap 204 is removed from the spout portion 203, and the ink can be extracted.

When replenishing the ink to the inkjet printer 200 using the ink replenishing container 201 in which the ink is stored in the container body 202, the user opens the cover 7 illustrated in FIG. 1 to expose the ink tank 16. The user removes the cap 204 of the ink replenishing container 201, and replenishes the ink to the ink tank 16 with the ink replenishing container 201 upside down, that is, with the spout portion 203 on the lower side and the container body 202 on the upper side. In the first embodiment, the maximum amount of ink that can be stored in the container body 202 of the ink replenishing container 201 is larger than the maximum amount of ink that can be stored in the ink tank 16. Therefore, the ink can be replenished to the ink tank 16 twice or more before the ink in the ink replenishing container 201 is used up. In a state where the ink in the ink replenishing container 201 is used up, there is almost no ink in the container body 202 of the ink replenishing container 201. This state of the ink replenishing container 201 is referred to as a state after use of the ink replenishing container 201.

FIG. 5 is a cross-sectional view illustrating the ink replenishing container 201 in a state where ink is not stored in the container body 202. The ink replenishing container 201 includes a container body 202, a spout portion 203 provided at an end portion opposite to a bottom portion of the container body 202, a cap 204 attachable to and detachable from the container body 202, and an ink bag 212 accommodated in the container body 202.

The container body 202 can store the ink bag 212. The spout portion 203 is provided at an end portion opposite to the bottom portion of the container body 202 in the axial direction of the container body 202, has a smaller diameter than the container body 202, and has an opening 213. The ink bag 212 capable of storing ink is provided inside the container body 202. The ink bag 212 is a bag-shaped ink storage member capable of storing ink, and has an opening 213 capable of spouting the stored ink. The cap 204 can seal the opening 213 of the ink bag 212 housed in the container body 202.

The ink bag 212 is formed such that its outer peripheral surface 223 adheres to an inner peripheral surface 224 of the container body 202. The container body 202 is configured to be able to store ink by storing the ink inside the ink bag 212. In the first embodiment, the ink bag 212 is formed of an acrylic synthetic resin. The ink bag 212 is not limited to an acrylic synthetic resin, and may be formed of a synthetic resin of nitrocellulose, polyamide, cyclized rubber, chlorinated rubber, urethane, or poval, or may be formed of a synthetic resin obtained by mixing two or more of these synthetic resins.

A recessed portion 222 is provided on the outer peripheral surface 223 of the ink bag 212. The recessed portion 222 is provided in at least a region (hereinafter, referred to as a closest region) closest to the inner peripheral surface 224 of the container body 202 on the outer peripheral surface of the ink bag 212, is recessed toward the inside of the ink bag 212 from the outer peripheral surface 223, and does not come into contact with the inner peripheral surface 224 of the container body 202. The recessed portion 222 may be provided at a position other than the closest region on the outer peripheral surface 223 of the ink bag 212.

In the first embodiment, a part not provided with the recessed portion 222 in the closest region of the outer peripheral surface 223 of the ink bag 212 comes into contact with and adheres to the inner peripheral surface 224 of the container body 202 in a state where the ink bag 212 is accommodated in the container body 202. FIG. 5 shows an example in which substantially the entire outer peripheral surface 223 of the ink bag 212 comes into contact with and adheres to the inner peripheral surface 224 in a state where the ink bag 212 is accommodated in the container body 202. In such a configuration, since the entire region of the outer peripheral surface 223 of the ink bag 212 can be said to be the closest region, the recessed portion 222 may be provided at an arbitrary position on the outer peripheral surface 223. In this case, the outer peripheral surface 223 of the ink bag 212 comes into contact with the inner peripheral surface 224 of the container body 202, and the recessed portion 222 does not come into contact with the inner peripheral surface 224 of the container body 202.

When the ink bag 212 to be described later is peeled off from the container body 202, the progress of peeling is promoted with the recessed portion 222 as a starting point. When at least one recessed portion 222 is provided, an effect of promoting the progress of peeling can be obtained.

In the example of FIG. 5, a plurality of recessed portions 222 is provided with a gap therebetween along the axial direction of the container body 202. Each of the recessed portions 222 is annularly provided around the axial direction of the container body 202. The shape of the recessed portion 222 is not limited thereto. Any shape may be used as long as the shape is formed on the outer peripheral surface 223 of the ink bag 212 and do not come into contact with the inner peripheral surface 224 of the container body 202.

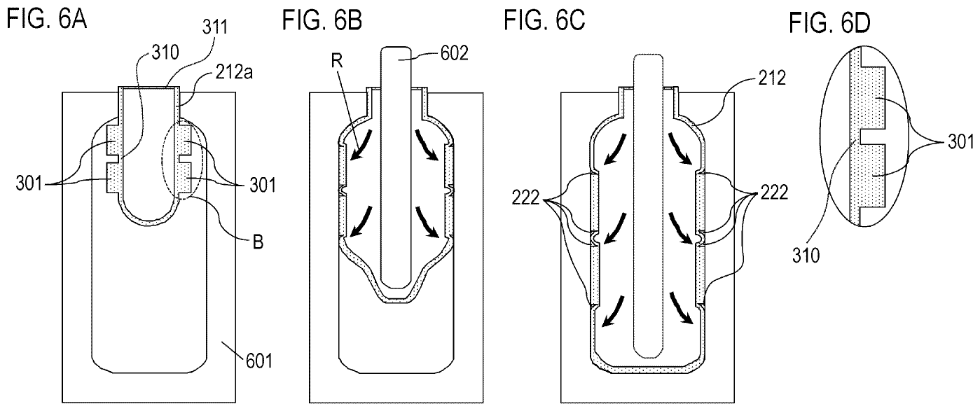

FIGS. 6A to 6D are diagrams illustrating a method for manufacturing the ink bag 212. As illustrated in FIG. 6A, a tubular preform 212a having a thick portion 301 and a thin portion 310 on the outer peripheral surface and having an opening 311 is formed by injection molding or the like, and heated by a heater to be set in a mold 601. Next, as illustrated in FIG. 6B, gas (high-pressure air) is blown into the preform 212a as indicated by an arrow R while the preform 212a is stretched by a stretching rod 602. The preform 212a is stretched in the vertical direction by the stretching rod 602 and is also expanded in the horizontal direction by the high-pressure air. By such stretch blow molding, the ink bag 212 having the recessed portion 222 is obtained as illustrated in FIG. 6C.

FIG. 6D is an enlarged view of the thick portion 301 and the thin portion 310 indicated by reference sign B in FIG. 6A. The preform 212a has a thick portion 301 and a thin portion 310, and the thick portion 301 has a temperature relatively lower than that of the thin portion 310 in a heating step before being set in the mold 601. Therefore, in the stretch blow molding step, the thick portion 301 is less likely to stretch than the thin portion 310. The thick portion 301 is extended to form the outer peripheral surface 223 of the ink bag 212, and the thin portion 310 is extended to form the recessed portion 222 of the ink bag 212. In this manner, the ink bag 212 is created.

Thereafter, the ink replenishing container can be manufactured by attaching the ink bag 212 to the container body 202 and filling the ink bag 212 with ink.

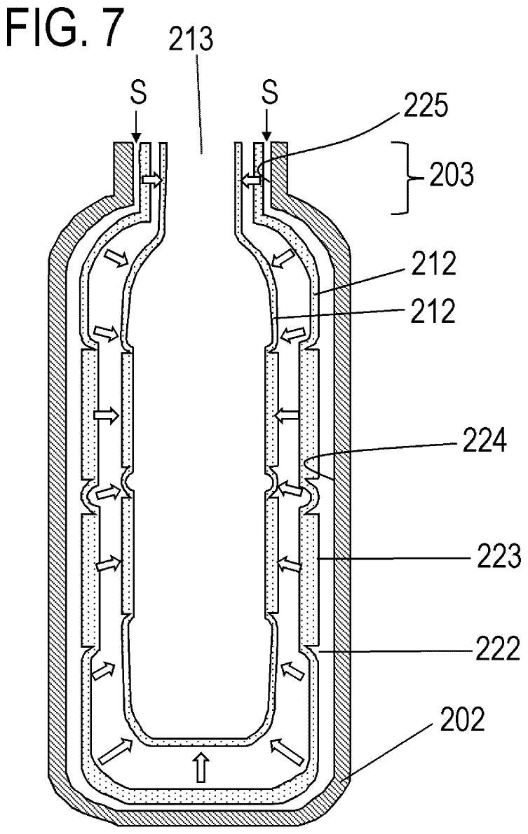

FIG. 7 is a diagram illustrating a state in which the ink bag 212 is peeled off from the container body 202. The ink bag 212 can be deformed into a shape that can be attached to and detached from the container body 202 in a state where the ink is not stored. In a case where the ink bag 212 is taken out from the container body 202, air is blown into a gap between the inner peripheral surface 225 of the spout portion 203 and the inner peripheral surface 224 of the container body 202 and the outer peripheral surface 223 of the ink bag 212 from the opening 213 toward the bottom surface direction of the container body 202 as indicated by an arrow S. The outer peripheral surface 223 of the ink bag 212 adhering to the inner peripheral surface 225 of the spout portion 203 and the inner peripheral surface 224 of the container body 202 is peeled off by the wind pressure of the air. Since the recessed portion 222 is formed on the outer peripheral surface 223 of the ink bag 212, the attachment area is smaller than a case where the outer peripheral surface of the ink bag adheres to substantially the entire inner peripheral surface 224 of the container body 202. Since the attachment area is small, the attachment force is small, and as a result, the film is easily peeled off. As illustrated in FIG. 7, the peeled ink bag 212 is gradually bent and has a reduced volume. The bent ink bag 212 is pulled out from the opening 213 of the spout portion 203 to the outside of the container body 202, whereby the ink bag 212 is separated from the container body 202.

In the first embodiment, the ink bag 212 is peeled off from the container body 202 by the wind pressure of the blown air, but may be peeled off by other methods.

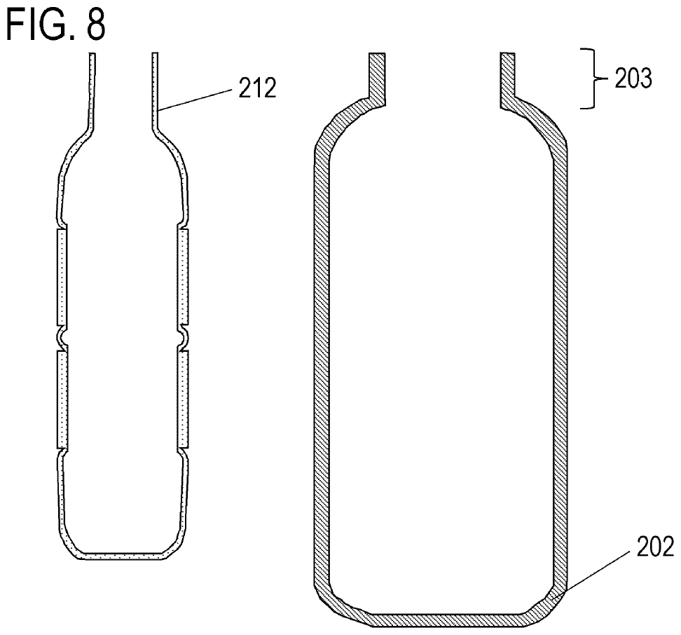

FIG. 8 is a cross-sectional view illustrating the ink bag 212 after being peeled off from the container body 202 and removed from the container body 202, and the remaining container body 202. In the used ink replenishing container 201, the ink adheres only to the inner peripheral surface of the ink bag 212. Therefore, by separating the ink bag 212 from the used container body 202, the residual ink does not adhere to the used container body 202. Therefore, the container body 202 after use can be reused.

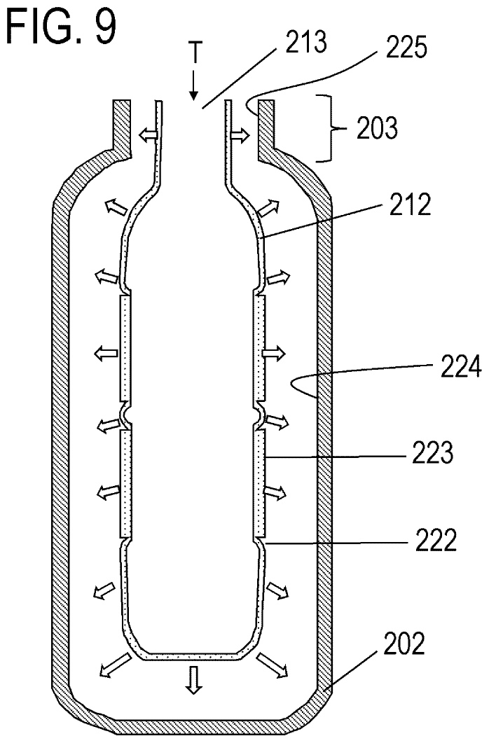

FIG. 9 is a diagram for explaining a method for remanufacturing the ink replenishing container 201. In a case where the used ink replenishing container 201 is reused to remanufacture the ink replenishing container 201, first, in the used ink replenishing container 201, the outer peripheral surface 223 of the used ink bag 212 is peeled off from the inner peripheral surface 224 of the container body 202 (peeling step, FIG. 7). Next, as described with reference to FIG. 8, the used ink bag 212 is taken out from the container body 202 and removed.

Next, as illustrated in FIG. 9, a new ink bag 212 is inserted into the container body 202 from the opening 213 of the spout portion 203, and air is blown into the inside of the ink bag 212 as shown by an arrow T. The pressure of the air expands the ink bag 212, and the outer peripheral surface 223 of the ink bag 212 adheres to the inner peripheral surface 224 of the container body 202 and the inner peripheral surface 225 of the spout portion 203.

After the new ink bag 212 is attached to the reused container body 202, the ink bag 212 of the container body 202 is filled with ink via the spout portion 203. After the ink is filled, the cap 204 is mounted to the container body 202, and the remanufacture of the ink replenishing container 201 is completed.

### Second Embodiment

Hereinafter, a second embodiment of the present invention will be described with reference to the drawings. In the following description, the same components as those of the first embodiment are denoted by the same reference numerals, and detailed description thereof will be omitted.

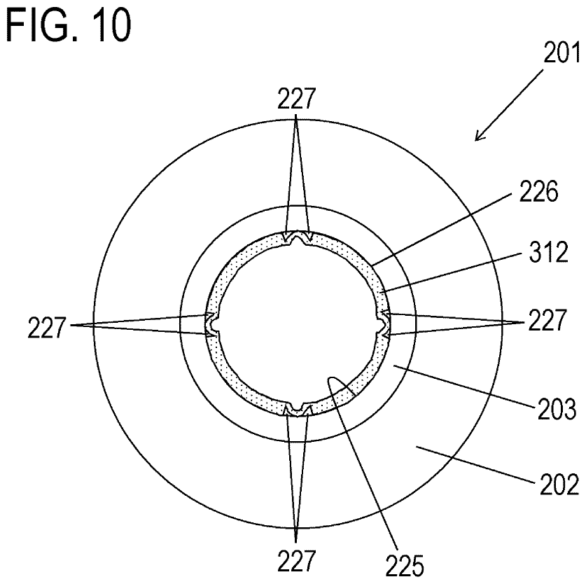

FIG. 10 is a top view illustrating a state in which the cap 204 of the ink replenishing container 201 in the second embodiment is removed. An ink bag 312 of the second embodiment has a recessed portion 222 similar to that of the first embodiment in the closest region close to the inner peripheral surface 224 of the container body 202 on the outer peripheral surface 223. Furthermore, a recessed portion 227 is also provided in the closest region closest to the inner peripheral surface 225 of the spout portion 203 of an outer peripheral surface 226 near the spout portion 203 of the ink bag 312. The recessed portion 227 does not come into contact with the inner peripheral surface 225 of the spout portion 203. The recessed portion 227 is formed linearly along the axial direction of the spout portion 203 on the outer peripheral surface 226. A plurality of recessed portions 227 is provided with a gap therebetween around the axial direction of the spout portion 203. The shape of the recessed portion 227 is not limited thereto. Any shape may be used as long as it is formed on the outer peripheral surface 226 in the vicinity of the spout portion 203 of the ink bag 312 and does not come into contact with the inner peripheral surface 225 of the spout portion 203.

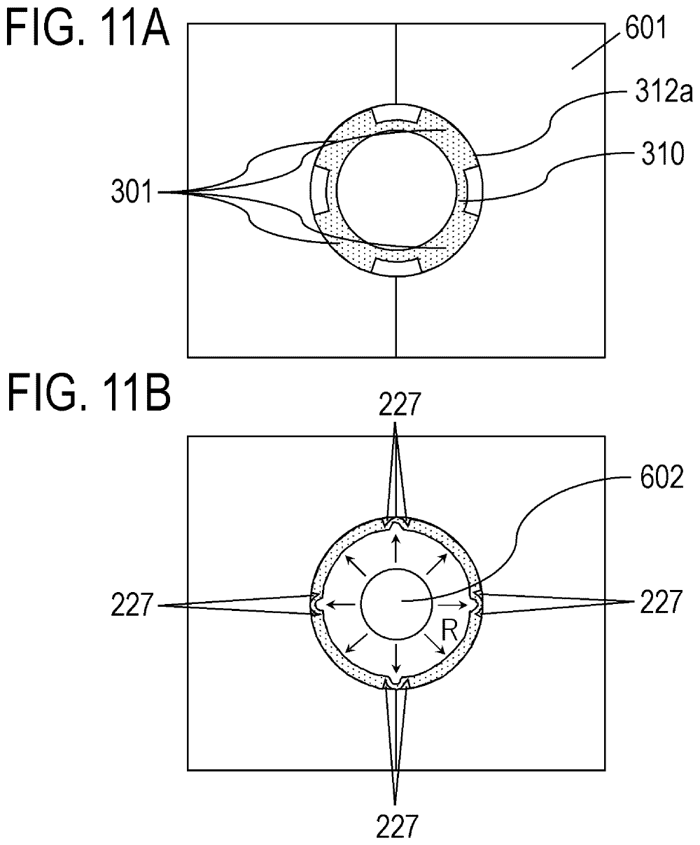

FIGS. 11A and 11B are diagrams illustrating a method for manufacturing the ink bag 312.

As illustrated in FIG. 11A, a preform 312a provided with the thick portion 301 is manufactured by injection molding or the like, heated by a heater, and set in the mold 601. Next, as illustrated in FIG. 11B, blowing is performed with air as indicated by an arrow R while stretching with the stretching rod 602. The preform 312a is stretched in the vertical direction by the stretching rod 602 and also expanded in the horizontal direction by the high-pressure air. By such stretch blow molding, the ink bag 312 having the recessed portion 227 is obtained as illustrated in FIG. 10.

The preform 312a has the thick portion 301 and the thin portion 310, and the thick portion 301 has a temperature relatively lower than that of the thin portion 310 in a heating step before being set in the mold 601. Therefore, in the stretch blow molding step, the thick portion 301 is less likely to stretch than the thin portion 310, and as a result, the recessed portion 227 is formed.

The ink bag 312 is peeled off in the same manner as in the first embodiment. Air is blown into a gap between the inner peripheral surface 225 of the spout portion 203 and the inner peripheral surface 224 of the container body 202 and the outer peripheral surfaces 226 and 223 of the ink bag 312 from the opening 213 toward the bottom surface direction of the container body 202. In the second embodiment, since the recessed portion 227 is provided on the outer peripheral surface 226 of the ink bag 312 adhering to the inner peripheral surface 225 of the spout portion 203 serving as an inlet through which air is blown, peeling is more likely to start. Since it is easy to create a trigger for peeling, the ink bag 312 is more easily peeled than in the first embodiment.

After the ink bag 312 is peeled off from the container body 202, the ink bag 312 is pulled out of the container body 202, so that the ink bag 312 can be separated from the container body 202 and removed from the ink replenishing container 201. After the used ink bag 312 is removed, a new ink bag 312 is attached to the remaining container body 202, and ink is injected into the ink bag 312 of the container body 202 via the spout portion 203. After the ink is injected, the cap 204 is mounted to the container body 202, and the remanufacture of the ink replenishing container 201 is completed.

According to the ink replenishing container 201 of the present disclosure described above, the container body 202 can be reused by peeling the ink bags 212 and 312 formed inside the container body 202 from the container body 202 and removing them from the container body 202. Furthermore, since the recessed portions 222 and 227 are provided on the outer peripheral surfaces 223 and 226 of the ink bags 212 and 312, the used ink bags 212 and 312 are easily peeled off from the container body 202. Therefore, the operation of removing the used ink bags 212, 312 from the used ink replenishing container 201 is easy, and the reuse of the container body 202 can be promoted. Furthermore, the amount of waste can be reduced as compared with the case of discarding the entire ink replenishing container 201 after use, and the reduction can be promoted. For these reasons, the technologies described in this specification have the potential to contribute to the achievement of a sustainable society, such as a decarbonized society/circular society.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-074435, filed on May 1, 2024, which is hereby incorporated by reference herein in its entirety.

What is claimed is:

1. An ink replenishing container for replenishing ink to a recording apparatus that performs recording by discharging ink onto a recording medium, comprising:
a bag-shaped ink storage member capable of storing ink, the ink storage member having an opening capable of spouting ink to be stored;
a container body capable of storing the ink storage member; and
a cap attachable to and detachable from the container body, the cap being capable of sealing the opening of the ink storage member stored in the container body,
wherein a recessed portion that is recessed toward an inside of the ink storage member from an outer peripheral surface is provided in a region closest to at least an inner peripheral surface of the container body in the outer peripheral surface of the ink storage member, and
wherein the recessed portion does not come into contact with the inner peripheral surface of the container body.

2. The ink replenishing container according to claim 1,
wherein a part where the recessed portion is not provided in the region closest to the inner peripheral surface of the container body adheres to the inner peripheral surface of the container body.

3. The ink replenishing container according to claim 1,
wherein the recessed portion provided in the region closest to the inner peripheral surface of the container body is annularly provided around an axial direction of the container body.

4. The ink replenishing container according to claim 1,
wherein a plurality of the recessed portions is provided with a gap therebetween along an axial direction of the container body.

5. The ink replenishing container according to claim 1,
wherein the ink replenishing container includes a spout portion provided at an end portion on a side opposite to a bottom portion of the container body, the spout portion having an opening and a diameter smaller than that of the container body, and
wherein the recessed portion is also provided in a region closest to an inner peripheral surface of the spout portion in the outer peripheral surface of the ink storage member.

6. The ink replenishing container according to claim 5,
wherein the recessed portion provided in a region closest to the inner peripheral surface of the spout portion is linearly provided along an axial direction of the spout portion.

7. The ink replenishing container according to claim 5,
wherein a plurality of the recessed portions is provided with a gap therebetween around an axial direction of the spout portion.

8. The ink replenishing container according to claim 1,
wherein the ink storage member is deformable into a shape that can be attached to and detached from the container body in a state where ink is not stored.

9. A method for manufacturing the ink replenishing container according to claim 1, comprising:
creating a tubular preform having an opening, the preform having a thick portion and a thin portion on an outer peripheral surface thereof;
heating the preform and setting the preform in a mold;
creating the ink storage member including the outer peripheral surface formed by extending the thick portion and the recessed portion formed by extending the thin portion by blowing gas into and expanding the preform;
attaching the ink storage member to the container body; and
filling the ink storage member with ink.

10. A method for remanufacturing the ink replenishing container according to claim 1, comprising:
peeling off, in the ink replenishing container which is used, the outer peripheral surface of the used ink storage member from the inner peripheral surface of the container body;
taking out the used ink storage member from the container body;
attaching the ink storage member which is new to the container body; and
filling the new ink storage member with ink.

11. The method according to claim 10,
wherein the peeling includes blowing air between the inner peripheral surface of the container body and the outer peripheral surface of the used ink storage member.
